(19) United States
(12) Patent Application Publication
(10) Pub. No.: US 2010/0037893 A1
(43) Pub. Date: Feb. 18, 2010

(54) Apparatus Having Cross Conditioned Breathing Air

(76) Inventors: William L. Grilliot, West Milton, OH (US); Mary I. Grilliot, West Milton, OH (US)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/192,558

(22) Filed: Aug. 15, 2008

(51) Int. Cl. A62B 7/02; A62B 17/00

(52) U.S. Cl. 128/202.19; 128/202.13; 2/458

(57) ABSTRACT

A self-contained breathing apparatus includes a tank of compressed air and an associated connector. A coaxial conduit extends from the connector to a face plate which might be used by a first responder. Air from the tank is coupled to the face plate via an internal conduit. Exhaled air from the face mask is carried away via an external conduit that surrounds the internal conduit, at least in part, and insulates the air being coupled to the face plate from ambient temperatures. The breathable air, flowing in the internal conduit also cools the exhaled air in the external conduit prior to that air flushing spaces between protective layers of the first responder's coat.

### FIELD

The invention pertains to self-contained breathing apparatus (SCBA) for use, for example, by firefighters. More particularly, the invention pertains to such apparatus having provisions to cool air exhaled by a user prior to that air flowing into the firefighters' jacket.

### BACKGROUND

Various types of air flush systems have been developed for use by first responders, such as firefighters. One example has been disclosed in previously issued U.S. Pat. No. 5,572,991 entitled Air Flush System for A Firefighter's Garment, Grilliot et al., issued Nov. 12, 1996 and owned by the assignee hereof. The '991 patent is hereby incorporated herein by reference. In the system of the '991 patent, air exhaled by the firefighter flows into the individual's protective jacket to flush air trapped between the layers of the firefighter's jacket.

Another example has been disclosed and claimed in US application No. 2006/0096592 A1, Grilliot et al., published May 11, 2006. The '6592 application is owned by the assignee hereof and incorporated herein by reference.

While known structures are effective for their intended purpose, the intense heat that firefighters are subjected to at times presents an ongoing challenge to provide as much cool, exhaled air as possible for flushing air trapped in the layers of the individual's garments, jacket and/or pants, for example. There is thus a continuing need for systems which can provide cooler air to flush the coats and pants of firefighters.

It would also be desirable if such systems were compatible with existing coats/pants used by firefighters to minimize the cost of department wide adoption of such systems.

### BRIEF DESCRIPTION OF THE DRAWINGS

FIG. 1 is a side view of a firefighter with an air flush system in accordance with the invention; and

FIG. 2 is a view partly in section illustrating additional details of the system of FIG. 1.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Embodiments of the invention cool a user's exhaled air by providing a flow of incoming cooler air, from an air tank for example, which is coaxial, and surrounded with the user's exhaled air. The exhaled air can then flow into and flush air trapped between layers of the user's garments.

In yet another aspect of the invention, the exhaled air, surrounding the incoming cooler air, would insulate the air coming into the user's face mask from the ambient high temperatures in which the firefighter might be working.

In a disclosed, exemplary, embodiment a coaxial hose between the air cylinder and the face plate will provide an inflow of relatively cool pressurized air from the cylinder to the face plate via an internal conduit. Exhaled air from the face plate, traveling opposite the inflowing pressurized air, in a surrounding external conduit, will both insulate that inflowing air from the heat of the ambient fire conditions and be cooled by it prior to flowing into and flushing the user's coat/pants.

A first regulator valve at the air tank can reduce the pressure of the inflowing air to the face plate. A second valve at the face mask can further reduce the pressure of the air received by the firefighter. An exhalation valve at the face mask can couple exhaled air to the external conduit to flush the user's coat/pants.

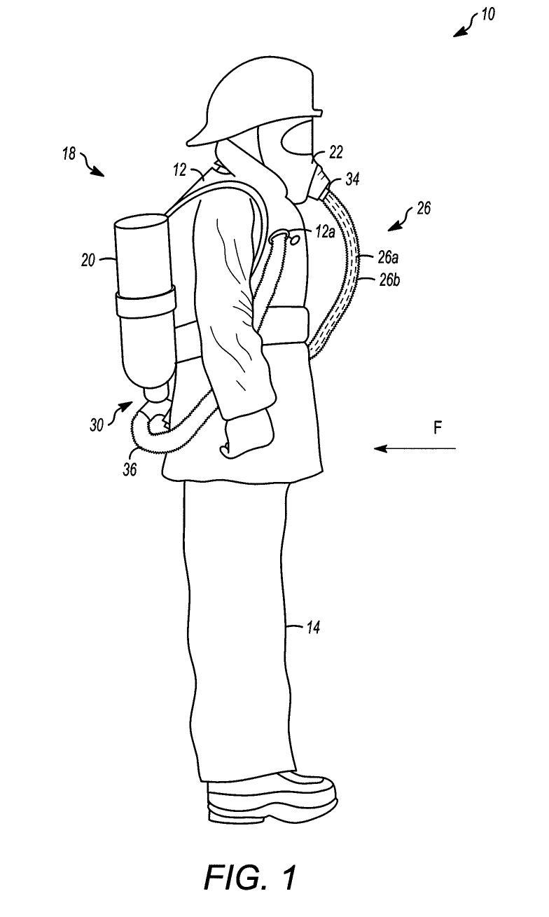

FIG. 1 illustrates a system 10, which embodies the invention, being worn by a firefighter F. Firefighter F is shown wearing a multi-layer, protective, exterior coat 12 and pants 14 of a type disclosed in the '991 patent and '6592 published application, both previously incorporated by reference. The system 10 can provide cooler exhaled air to flush the coat 12, or alternately the pants 14, or both all without limitation.

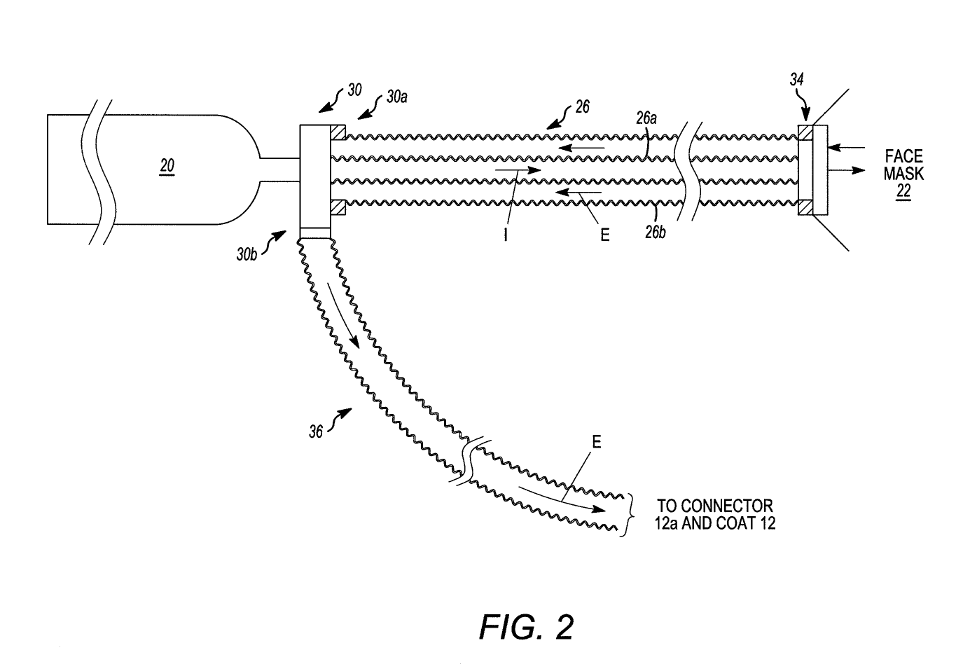

With respect to FIGS. 1, 2 a container of compressed air 20 is coupled to a facemask 22 by a coaxial hose or conduit 26. A valve and connector assembly 30 couples a reduced pressure flow of breathable air from tank 20 to internal conduit 26a. The hose 26 and conduit 26a are coupled to a connector 34 on the face mask 22. The inflowing breathable air I in conduit 26a can be expected to be cooler than the ambient fire related temperatures.

Face mask 22 can include a second pressure reducing value, not shown, that emits air into the face mask for the fire fighter to breathe at ambient pressure. Mask 22 also carries an exhalation valve which is coupled to conduit 26b which surrounds conduit 26a.

Air exhaled by the firefighter, or other first responder insulates the inflowing cooler air from the external fire related temperatures. Additionally, that internal cooler air will help to reduce the temperature of the exhaled air in the external conduit 26b. Optionally, heat exchangers could be provided in one or both of the conduits.

In the disclosed embodiment, exhaled air E is coupled via connector and valve assembly 30 through an outflow connector 30b to a hose 36. Hose 36 is in turn coupled to a connector 12a to provide a flow of cool air to flush the coat 12. It will be understood that the location of the connector 12a is exemplary and not a limitation of the invention. Other configurations which input the exhaled air E into the spaces between layers of the coat 12 come within the spirit and scope of the invention.

Those of skill will also understand that the flow of cool air can also, or in addition to, be directed to a region formed by an interior surface of the coat 12, or pants 14 and other clothing, separate from coat 12 or pants 14, which might be worn by fire fighter F. In this embodiment, the cool air would flow in the space(s) between the innermost portion of the coat 12 or pants 14 and the user's street clothes.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A self-contained breathing apparatus comprising:
a tank of a compressed gas;
a face mask; and
a coaxial conduit that extends between the tank and the mask with a first portion of the conduit defining a flow path from the tank to the mask and where a second portion of the conduit defines a second flow path from the mask, the first flow path being at least in part surrounded by the second path.

2. An apparatus as in claim 1 which includes a first valve carried adjacent to the tank, coupled to the conduit.

3. An apparatus as in claim 2 which includes a second valve carried on the face mask, coupled to the conduit.

4. An apparatus as in claim 1 where the second flow path is couplable to a protective garment.

5. An apparatus as in claim 3 where the second flow path terminates at a connector and is couplable to a protective garment.

6. An apparatus as in claim 5 where the garment has multiple layers with space therebetween and where the second flow path and the space together provide an extended flow path from the face mask through the garment.

7. An apparatus as in claim 1 where the face mask carries an exhalation valve coupled to the second flow path.

8. An apparatus as in claim 7 where the second flow path terminates at a connector and is couplable to a protective garment.

9. An apparatus as in claim 8 where the first and second flow paths are coupled to a valve assembly carried by the tank.

10. An apparatus as in claim 9 where the valve assembly defines an exhalation output port coupled to the second flow path.

11. A method comprising:
providing a first flow of breathable air;
coupling the first flow to a breathing location;
directing a second flow of air from the breathing location, while separating the flows and simultaneously cooling the second flow with the first flow; and
delivering the second flow to a flushing region.

12. A method as in claim 11 where cooling includes surrounding the first flow with the second flow along a common flow segment.

13. A method as in claim 11 which includes, using the second flow to insulate the first flow from adjacent heat.

14. A method as in claim 12 where delivering includes cooling a selected garment with the second flow.

15. A method as in claim 14 which includes providing a flushing region within the garment to be cooled by the second flow.

16. A flush system for a protective garment comprising:
a garment having a plurality of layers, a space being located between two of the layers;
a first conduit that delivers gas from a source of compressed gas to a face mask; and
a second conduit which surrounds the first conduit, for at least a predetermined interval, and that delivers gas from the mask to the space.

17. A flush system as in claim 16 where the garment comprises at least one of a multi-layer jacket, or multi-layer pants.

18. A flush system as in claim 16 which includes a source of compressed gas coupled to at least one of the conduits.

19. A flush system as in claim 18 where the source carries a multi-port valve with at least two input ports.

20. A flush system as in claim 18 where the garment defines an inflow port for coupling gas from the second conduit into the space, and where the garment defines an outflow port from the space.

21. A flush system for a fire resistant protective garment comprising:
a fire resistant protective garment having an exterior fire resistant surface and an interior surface;
a first conduit that delivers gas from a source of compressed gas to a face mask; and
a second conduit which surrounds the first conduit, for at least a predetermined interval, and that delivers gas from the mask to a region adjacent to the interior surface.
